(19) United States
(12) Patent Application Publication
(10) Pub. No.: US 2015/0357838 A1
(43) Pub. Date: Dec. 10, 2015

(54) BATTERY SYSTEM

(71) Applicant: Robert Bosch GmbH, Stuttgart (DE)

(72) Inventor: Johannes Federle, Rottenburg (DE)

(21) Appl. No.: 14/723,531

(22) Filed: May 28, 2015

(30) Foreign Application Priority Data
Jun. 4, 2014 (DE) 10 2014 210 648.6

(51) Int. Cl. H02J 7/00

(52) U.S. Cl. CPC H02J 7/007

(57) ABSTRACT

A battery system, having at least one battery cell, wherein a circuit arrangement is provided in a negative current path. The circuit arrangement includes two series-connected field-effect transistors, of which the battery-cell-side field-effect transistor has a charge-current-blocking diode path and can be bridged by a precharging path with a precharging resistor, and the field-effect transistor which is remote from the battery cell has a discharge-current-blocking diode path. The system also includes a voltmeter for detecting a voltage present across the field-effect transistor directly upstream and downstream of the field-effect transistor which is remote from the battery cell; and a current sensor for detecting a current flowing through the negative current path.

The present invention relates to a battery system with a particularly inexpensive means of error detection for a circuit arrangement. The present invention also relates to a method for operating a battery system which enables an inexpensive means of error detection for a circuit arrangement.

Batteries, such as lithium-ion batteries, for example, are widespread in many day-to-day applications. They are used, for example, in computers, for instance laptops, mobile telephones, smartphones and in other applications. Batteries of this type also offer advantages in the electrification of vehicles, for instance hybrid vehicles or electric vehicles, which is strongly encouraged nowadays.

Lithium-ion battery systems comprise a plurality of lithium-ion cells which are electrically interconnected in series or in parallel and monitored by a battery management system and integrated to form an overall system. In order to ensure the safety of the system, isolating switches are usually incorporated in order to be able to disconnect the battery cells or isolate them from a consumer in the event of a fault. In order still to be able to effect isolation, even in the event of failure of a switch, the switches are often configured to be redundant.

In addition, it is often necessary to measure the battery current, for which purpose appropriate current sensors are provided. A current measurement such as this is often likewise configured to be redundant, with the result that two current sensors are provided which are checked for plausibility against one another for a corresponding diagnosis.

A diagnosis device for detecting a fault in a circuit between an energy store and an electrical device is known from document US 2013/0320986 A1. The diagnosis device comprises a multiplicity of switches, a voltage-measuring device and a control unit.

Document DE 10 2013 203 545 A1 describes a switch-failure detection device with a switch, a rectifier, a switch-voltage detection circuit and a control device. The switch is arranged in a path in which a charge current and a discharge current flow. The rectifier allows the discharge current to pass by bypassing the switch when the switch is switched off. The detection circuit detects a voltage between an input and an output of the switch.

### SUMMARY OF THE INVENTION

The subject of the present invention is a battery system, having at least one battery cell, wherein a circuit arrangement is provided in a negative current path, characterized in that the circuit arrangement has at least the following as circuit components:
two series-connected field-effect transistors, of which
the battery-cell-side field-effect transistor has a charge-current-blocking diode path and can be bridged by a precharging path with a precharging resistor, and
the field-effect transistor which is remote from the battery cell has a discharge-current-blocking diode path;
a voltmeter for detecting a voltage present across the field-effect transistor directly upstream and downstream of the field-effect transistor which is remote from the battery cell; and
a current sensor for detecting a current flowing through the negative current path.

A battery system as described above enables a plausibility check of the individual circuit components to be performed with only a few necessary components, as a result of which it is possible to avoid individual components being fitted multiple times in wide areas.

“The battery-cell-side field-effect transistor” can be understood here to mean that the field-effect transistor of the two series-connected field-effect transistors is arranged in terms of circuitry between the further field-effect transistor and the at least one battery cell.

Correspondingly, “the field-effect transistor which is remote from the battery cell” can be understood to mean that said field-effect transistor is arranged in terms of circuitry after the battery-cell-side field-effect transistor when coming from the at least one battery cell.

In addition, “a charge-current-blocking diode path” can be understood to mean a current-conducting path which has a diode which, in at least one operating state, is impermeable to a charge current for the battery cell or is reverse-biased for such a current direction, but allows a discharge current to pass or is forward-biased for a discharge current of the at least one battery cell.

Correspondingly, “a discharge-current-blocking diode path” can be understood to mean a current-conducting path which has a diode which, in at least one operating state, is impermeable to a discharge current for the battery cell or is reverse-biased for such a current direction, but allows a charge current to pass or is forward-biased for a charge current of the at least one battery cell.

A battery system of this type may be, for example, a component part of an at least partially electrically driven vehicle, such as a hybrid vehicle or an electric vehicle, for example, but the present invention is not limited to this application, as is readily understood by a person skilled in the art.

The battery system described above comprises at least one battery cell. A battery cell of this type is not restricted in its type and can, in principle, be any known battery cell. Purely by way of example, the battery cell may be a lithium-ion cell. Furthermore, the present invention is described below with only one battery cell. In this case, the description of the present battery system is, in a manner which is readily understandable to a person skilled in the art, also disclosed for the provision of a plurality of battery cells, in particular connected in series.

The battery system has a positive and a negative current path. In this case, the positive and negative current paths run from the at least one battery cell to an electrical consumer or are connectable to the consumer. In this case, the positive current path is the current path which leads from the positive connection or the anode of the battery cell to the consumer or is connectable thereto. Correspondingly, the negative current path is that which leads from the negative contact of the battery cell or from the cathode to the consumer.

In the negative current path, the battery system described above has a circuit arrangement. A circuit arrangement such as this comprises at least the following components; in particular, it may consist of the following components.

Firstly, the circuit arrangement comprises two series-connected field-effect transistors. These may each be configured, in particular, as MOSFETs and hence have a configuration which is known per se. A field-effect transistor such as this, for instance a MOSFET in particular, can be used, in particular, for example in the event of a fault in a battery cell, to be able to isolate said battery cell or all of the battery cells from the consumer. Thus, the field-effect transistors can be used as electric switches which can switch the appropriate line so as to be de-energized in the event of a fault. As a result of this, great damage after a fault can be reliably prevented or at least significantly reduced. In the case of a field-effect transistor, this can take place in a problem-free and particularly dynamic manner known in principle to a person skilled in the art.

By connecting the two provided field-effect transistors or, in particular, MOSFETs in series, one of the field-effect transistors is present as battery-cell-side field-effect transistor while the other of the two field-effect transistors is present as field-effect transistor which is remote from the battery cell. Thus, there only needs to be a combination of two field-effect transistors, for example MOSFETs, present, which is also referred to as a back-to-back (B2B) combination; a redundant circuit is not necessary.

In this case, provision is made for the battery-cell-side field-effect transistor to have a charge-current-blocking diode path and to be able to be bridged by a precharging path with a precharging resistor.

Thus, provision is made for the battery-cell-side field-effect transistor to have a diode path, which is known per se for MOSFETs, in particular. The diode path or the diode in the diode path is in this case arranged such that it has a blocking action in the direction of a charge current but allows a discharge current to pass. Thus, a charge current can flow through the battery-cell-side field-effect transistor only in the event that the field-effect transistor is open, that is to say forward-biased for current conduction, while a charge current can always pass through the diode path in the event of fault-free operation. Thus, said field-effect transistor can prevent the charging of the battery cell.

Furthermore, the battery-cell-side field-effect transistor can be bridged by a precharging path with a precharging resistor. In particular, only the battery-cell-side field-effect transistor can be bridged by a precharging path with a precharging resistor, as a result of which only half of the abovementioned B2B combination can be bridged or is bridged. In this regard, in particular, a further switch can be provided in the precharging path, which further switch can likewise be configured, for example, as a field-effect transistor, for instance a MOSFET with internal resistance (RDS) which is known per se and is used as precharging resistor. In this case, the RDS of the MOSFET can be regulated such that, during the precharging process, a constant current flows from the battery. Such a precharging path with a precharging resistor can function, in particular, when the bridged switch or field-effect transistor is closed. If, in particular, the field-effect transistor as isolating switch were turned hard on, then, owing to the high input capacitance of the electrical devices used, a very high current would flow, which can lead to premature aging or even to damage to the switch or the capacitors. However, in order to prevent this, the precharging path is provided as a so-called precharging circuit, which limits the current which initially flows, with the result that, when the bridged field-effect transistor, for example the MOSFET, is closed, likewise only a limited current flows. The purpose of the precharging circuit here is current limiting in the field-effect transistor in a manner known per se and also, in particular, current limiting for the battery cells and further external components, such as the capacitor, which is charged.

With regard to the field-effect transistor which is remote from the battery cell, provision is also made for said field-effect transistor which is remote from the battery cell to have a discharge-current-blocking diode path. The diode path or the diode in the diode path is thus arranged such that it has a blocking action in the direction of a discharge current but allows a charge current to pass. Thus, a discharge current can flow through the battery-cell-side field-effect transistor only in the event that the field-effect transistor is open, that is to say forward-biased for current conduction, while a charge current, for example a precharging current, can pass through the diode path, for example via the body diode of the field-effect transistor. Said field-effect transistor can thus prevent the discharging of the battery cells.

Furthermore, the circuit arrangement described above has a voltmeter which can measure a voltage present across the field-effect transistor directly upstream and downstream of the field-effect transistor which is remote from the battery cell in the negative current path of the battery system. Such a voltmeter can have, for example, an operational amplifier. “A voltage present directly upstream and downstream of the field-effect transistor which is remote from the battery cell” is also intended here to mean, in particular, that the voltage is present across the field-effect transistor substantially at the input and the output of the field-effect transistor and thus can be measured there, wherein, apart from an optional electrical line, no further circuit components are present within the voltage which is present or measured.

The circuit arrangement of the battery system described above comprises as further element a current sensor for detecting a current flowing through the negative current path. In this case, the current sensor can, in particular, be connected in series with the field-effect transistors. Furthermore, the current sensor can, in principle, be configured in any suitable form. By way of example, the current sensor can have a shunt resistor and a voltmeter or an operational amplifier.

What can be enabled, in particular, by a circuit arrangement as described above is that an electrical line can be quickly and safely isolated. As a result of this, the level of safety of a battery system can be particularly high. Furthermore, a circuit arrangement such as this can be configured with a few inexpensive components and hence allow a plausibility check to be performed for the individual components. Thus, the circuit arrangement described above can be used to ensure the operation of a battery system in a particularly inexpensive manner.

In particular, a redundant configuration of a multiplicity of components of the electrical circuit of the battery system can be avoided by a circuit arrangement as described above, which can save significant costs. This can be an advantage, in particular, for battery systems with a lower voltage level, since these often have to be configured in a highly optimized manner in order to meet set cost requirements. Therefore, in particular, the omission of redundant circuits or circuit components can be a significant advantage. In this case, it may be of particular advantage for the battery system to be one which provides a voltage of up to 75 V, for example of up to 50 V, by way of example of 48 V.

In this case, the present circuit arrangement can use components which are often already present for a diagnosis, wherein, in particular, a precharging current can be used in order to test the functioning of the components or to be able to perform a plausibility check for circuit components.

In summary, the above-described battery system can thus enable in a simple and inexpensive manner a plausibility check to be performed for circuit components for controlling the battery system in respect of disconnection and current measurement.

With regard to further advantages and features of the battery system described above, reference is hereby explicitly made to the explanations in connection with the method according to the invention for operating a battery system, to the figures and to the description of the figures.

The subject of the present invention is also a method for operating a battery system, in particular a battery system as described above in detail, in which a function check is performed for at least one circuit component.

A method as described above makes it possible in a simple and inexpensive manner to identify already when switching on and, in particular, precharging whether one of the components or whether one of the aforesaid circuit components present in the negative current path is faulty in a safety-critical manner. By way of example, it is possible to detect whether a switch cannot open or the current measuring device is not measuring correctly, as described below in detail. Faults which do not lead to a safety-critical state can be determined later during normal operation of the battery system, that is to say, for example, after precharging.

If a function check of a circuit component as described above was performed, provision can also be made for a warning message to be output or for the battery system to be transferred into an emergency operating mode, for example, disconnected, in the event that an error is detected during a function check, that is to say, for example, if a safety-critical function disturbance of a circuit component is present. By way of example, an error message can be transmitted in a battery control system, for instance in a battery management system, or the system can be transferred for example into an emergency operating mode, also referred to as a limp-home operating mode. In this case, by way of example, only a limited power can be output or, in the case of a hybrid system, the electric drive can be switched off, for example.

In this case, for example, a function check of the battery-cell-side field-effect transistor or of the precharging resistor can take place on the basis of a current measurement of the precharging current flowing through the negative current path. If one of these circuit components is faulty, the intermediate circuit capacitor cannot discharge. If a precharging process is to take place and the measured current is equal to 0, it can be assumed that there is a fault in one of these circuit components.

With regard to a function check of the field-effect transistor which is remote from the battery cell, this can take place by detection of a voltage present across the field-effect transistor directly upstream and downstream of the field-effect transistor which is remote from the battery cell while a precharging current is flowing. Said circuit component is not actuated during the precharging process; said switch or said field-effect transistor is thus open, it being possible, however, for the precharging current to flow via the diode path. However, this causes a volt drop which, depending on the technology used, by way of example and not in a limiting fashion, can be in the region of 0.7 V. Said volt drop can be determined using the voltmeter as described above. If the volt drop does not occur, the field-effect transistor, for example the MOSFET, is conductive and, in particular, short-circuited, with the result that the presence of an erroneous state is detectable and the system can be brought into an error state, for example.

With regard to a function check of the current sensor, this can take place by comparison of the current flowing during a precharging process, that is to say the precharging current which actually flows, with a predefined threshold value of the precharging current. This is possible because the precharging current is known in principle.

If a substantially deviating current is measured, which has at least a predetermined deviation, it can be assumed that there is a fault in the current sensor or in the precharging resistor. The predefined or defined value can in this case be supplied by a battery management system on the basis of the voltage source or on the basis of the battery cells or stored in a look-up table.

With regard to a check of the current sensor, a current measurement during normal operation, that is to say after a precharging process, can take place by detection of a voltage present across the field-effect transistor directly upstream and downstream of the field-effect transistor which is remote from the battery cell while a discharge current is flowing in order thus to effect redundant current measurement in a particularly inexpensive manner. Thus, in other words, provision can be made for a function check of the function of the current sensor or current meter to take place by a voltage measurement of the voltage present across the field-effect transistor upstream and downstream of the field-effect transistor which is remote from the cell during discharging of the battery.

With respect to further advantages and features of the abovedescribed method for operating a battery system, reference is hereby explicitly made to the explanations in connection with the battery system, the FIGURE and the description of the FIGURE.

### BRIEF DESCRIPTION OF THE DRAWINGS

Further advantages and advantageous configurations of the subject matter of the invention are illustrated in the drawing and explained in the following description. In this case, it should be noted that the drawing is merely descriptive and has not been conceived to limit the invention in any way. In the drawing:

FIG. 1 shows a schematic view of a configuration of a battery system according to the invention which is connected to an electrical consumer.

### DETAILED DESCRIPTION OF THE DRAWINGS

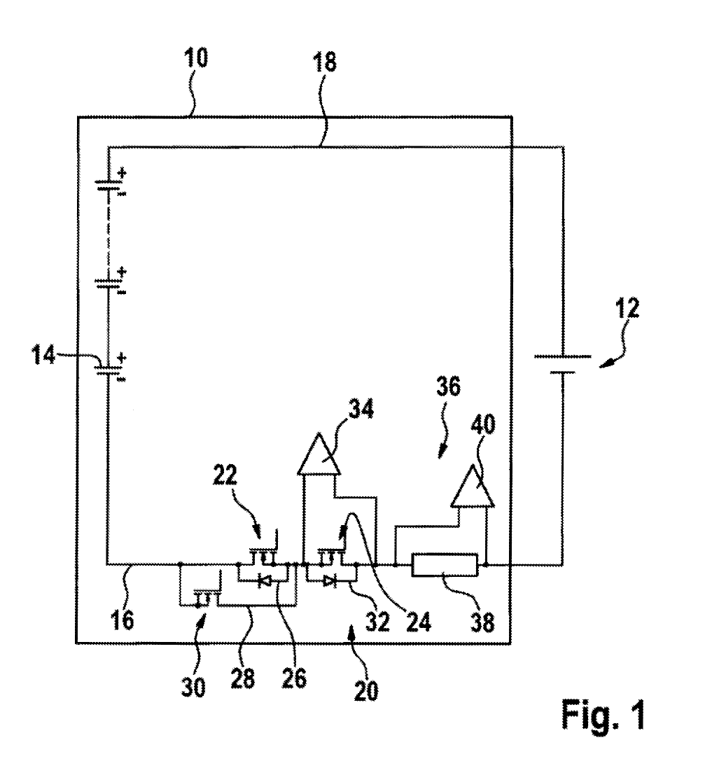

FIG. 1 shows a battery system 10 which is connected to an electrical consumer 12. By way of example, such a battery system 10 may be a component part of an at least partially electrically driven vehicle, in which case the electrical consumer 12 may be, for example, an electric motor.

The battery system 10 comprises at least one battery cell 14, according to FIG. 1 a multiplicity of battery cells 14, which is connected to a negative current path 16 and a positive current path 18, wherein the electrical consumer 12 is supplied with power through the negative 16 and positive 18 current paths.

A circuit arrangement 20 is provided in the negative current path 16 in order, for example, to interrupt the negative current path 16 or to perform a current measurement in the negative current path 16. The circuit arrangement 20 here comprises at least the following components:
two series-connected field-effect transistors 22, 24, for example MOSFETs, of which
the battery-cell-side field-effect transistor 22 has a charge-current-blocking diode path 26 and can be bridged by a precharging path 28 with a precharging resistor 30, and
the field-effect transistor 24 which is remote from the battery cell has a discharge-current-blocking diode path 32;
a voltmeter 34 for detecting a voltage present across the field-effect transistor 24 directly upstream and downstream of the field-effect transistor 24 which is remote from the battery cell; and
a current sensor 36 for detecting a current flowing through the negative current path, for example comprising a shunt resistor 38 and a voltage measuring device 40, which may be configured as an operational amplifier.

1. A battery system comprising:
at least one battery cell,
a circuit arrangement provided in a negative current path, the circuit arrangement including
a first field-effect transistor and a battery-cell-side field-effect transistor connected in series,
the battery-cell-side field-effect transistor having a charge-current-blocking diode path, wherein the battery-cell-side field-effect transistor can be bridged by a precharging path with a precharging resistor, and
the first field-effect transistor located remote from the battery cell and having a discharge-current-blocking diode path;
a voltmeter for detecting a voltage across the field-effect transistor; and
a current sensor for detecting a current flowing through the negative current path.

2. The battery system according to claim 1, wherein the precharging resistor is implemented using a field-effect transistor.

3. A method for operating a battery system that the method comprising:
performing a function check of at least one of the components in a circuit including
a first field-effect transistor located remote from the battery cell and having a discharge-current-blocking diode path,
a battery-cell-side field-effect transistor connected in series with the first field-effect transistor,
the battery-cell-side field-effect transistor having a charge-current-blocking diode path, wherein and the battery-cell-side field-effect transistor can be bridged by a precharging path with a precharging resistor, and
a voltmeter for detecting a voltage across the field-effect transistor; and
a current sensor for detecting a current flowing through the negative current path.

4. The method according to claim 3, wherein a function check of the battery-cell-side field-effect transistor or of the precharging resistor takes place on the basis of a current measurement of the precharging current flowing through the negative current path.

5. The method according to claim 3, wherein a function check of the first field-effect transistor takes place by detection of a voltage across the first field-effect transistor while a precharging current is flowing.

6. The method according to claim 3, wherein a function check of the current sensor takes place by comparison of the current flowing during a precharging process with a predefined threshold value of the precharging current.

7. The method according to claim 3, wherein a function check of the current sensor takes place by detection of a voltage across the first field-effect transistor while a discharge current is flowing.

8. The method according to claim 3, wherein in the event of an error being detected during a function check, a warning message is output, the battery system is transferred into an emergency operating mode, or both.
